(19) United States
(12) Patent Application Publication
(10) Pub. No.: US 2013/0031187 A1
(43) Pub. Date: Jan. 31, 2013

(54) METHOD AND SYSTEM FOR GENERATING CUSTOMIZED CONTENT FROM A LIVE EVENT

(71) Applicants: Bhatia Rajesh, Bangalore (IN); Pant Lakshana, Bangalore (IN)

(72) Inventors: Bhatia Rajesh, Bangalore (IN); Pant Lakshana, Bangalore (IN)

(21) Appl. No.: 13/229,775

(22) Filed: Sep. 12, 2011

(30) Foreign Application Priority Data
Jul. 30, 2011 (IN) 2686/CHE/2011

(51) Int. Cl. G06F 15/16

(52) U.S. Cl. 709/206; 709/204

(57) ABSTRACT

A server system receives event content for a live event. The server system determines user preferences for the live event filters the received content according to the user preferences. The system prepares customized content for the user based on the filtered content.

### RELATED APPLICATION

Benefit is claimed under 35 U.S.C. 119(a)-(d) to Foreign application Serial No. 2686/CHE/2011, filed in INDIA entitled “METHOD AND SYSTEM FOR GENERATING CUSTOMIZED CONTENT FROM A LIVE EVENT” by Hewlett-Packard Development Company, L.P., filed on Jul. 30, 2011, which is herein incorporated in its entirety by reference for all purposes.

### BACKGROUND

Virtual meetings and/or conferences allow multiple participants in remote locations to interact (e.g., teach, share, learn, discuss, etc.) using various communication tools. For example, participants can dial in to a phone conference via telephone or computer. In addition, participants can connect to a virtual room where electronic documents, images or other information may be shared. While presentation materials (e.g., slides, documents, etc.) are often distributed after a meeting, participants in the meeting often gain additional information and insights not contained in the distributed presentation materials.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a server system according to various embodiments.

FIG. 2 is a block diagram illustrating a server system according to various embodiments.

FIG. 3 is a flow diagram of operation in a server system according to various embodiments.

FIG. 4 is a flow diagram of operation in a server system according to various embodiments.

### DETAILED DESCRIPTION

Embodiments described herein allow printers or other devices to connect to live events (e.g., audio conferences, instant messaging meetings, etc.) and glean relevant content to be provided back to a user.

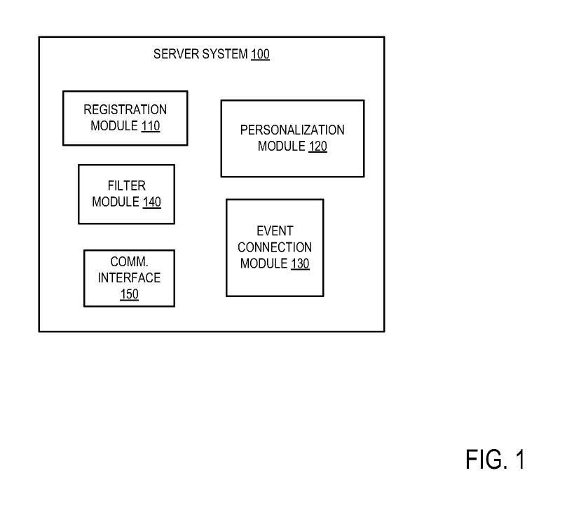

FIG. 1 is a block diagram illustrating a server system according to various embodiments. FIG. 1 includes particular components, modules, etc. according to various embodiments. However, in different embodiments, more, fewer, and/or other components, modules, arrangements of components/modules, etc. may be used according to the teachings described herein. Various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these. In addition, various components, modules, etc. described herein may be located on the same network-connected server device or they may be distributed across multiple network-connected server devices belonging to the server system.

Server system 100 includes a registration module 110 to receive user input for registering for a live event. As used herein, a live event includes any event in which a person may participate remotely (e.g., via teleconference, virtual room, instant messaging, video conference, etc.). Registration information might include conference codes, dial-in numbers, or other information for accessing the live event. Registration information might include personal information (e.g., name, email address, etc.), personal access codes, and/or payment information. In addition, the user registering for the live event might identify a device that will be used to participate in the live event as a proxy for the user. For example, the user may have previously registered one or more devices (e.g., web-enabled printers, computing devices, mobile devices, etc.) with server system 100.

Personalization module 120 determines user preferences for the live event. User preferences may be based on event-specific user input, historical usage preferences and/or patterns, and/or general user profile settings managed by the user. For example, the user may desire content related to a specific topic or content shared by a particular person.

Event connection module 130 receives event content for the live event. For example, in the case of an audio conference, event connection module 130 attaches to the audio conference by dialing the designated conference number at the designated time of the event and receiving streaming data (e.g., via Real-Time Transport Protocol (RTP), Session Initiation Protocol (SIP) or other suitable communications protocol). Similarly, event connection module 130 may attach to an IM conference or virtual room using the appropriate address and/or login information (e.g., via SIP or other suitable protocol). Once connected, event content received by event connection module 130 is passed to filter module 140 to generate customized content for the user based on the user preferences. For example, the user might be a student in a history class and may be specifically interested in any discussion about a particular historical event that is likely to be part of a presentation. Filter module 140 applies content filters to the received content to generate customized content according to the user's preferences.

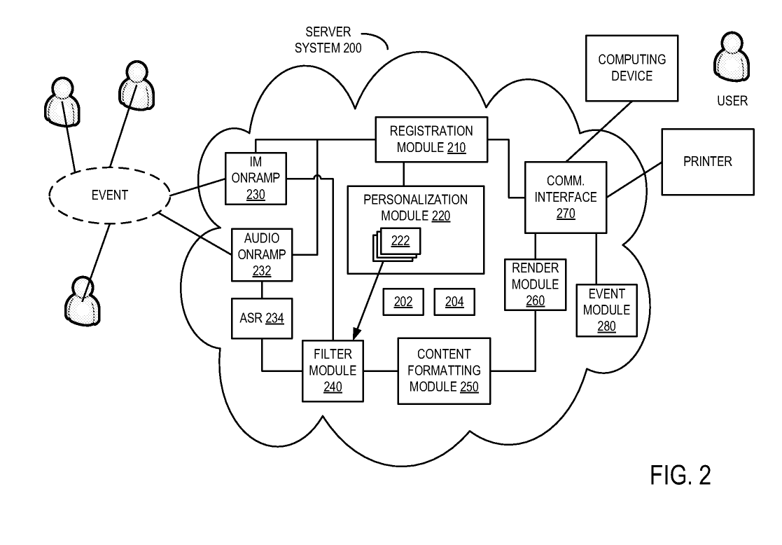

FIG. 2 is a block diagram illustrating a server system 200 according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

As illustrated, server system 200 includes a variety of components, modules, etc. in a cloud. The illustrated cloud is indicative of a cloud-computing infrastructure. In other words, the modules, components, etc. of server system 200 are communicatively connected (e.g., via the Internet). Accordingly, illustrated components, modules, etc. may exist in physically distinct locations on separate physical devices. However, some or all components, modules, etc. could be combined into a single network-connected (e.g., Internet-connected) physical device.

In an example, a user, wishing to participate in a live event, connects to server system 200 via a web browser on a computing device and/or printer. The connecting device may be registered to the user on server system 200. From the web browser, the user may find the event information and registration instructions. Registration module 210 receives event registration information provided by the user via communication interface 270. As used herein, an event could be a single-session event (e.g., a single meeting) or it could be a multi-session event (e.g., a course held once a week for several weeks). Registration information might include conference codes, dial-in numbers, or other information for accessing the live event. The information might also include personal information (e.g., name, email address, etc.), personal access codes, and/or payment information. In addition, the user registering for the live event might identify a device that will be used to participate in the live event as a proxy for the user (e.g., a registered printer or other suitable computing device).

Personalization module 220 determines user preferences for the live event. User preferences may be based on event-specific user input, historical usage preferences and/or patterns, and/or general user profile settings managed by the user. For example, the event may involve a panel of presenters and the user may have a preference for content specifically shared by one particular presenter. Or, in the case of a multi-session event, the user may prefer to receive content only for selected sessions. Other suitable preferences could be provided by the user and/or determined by personalization module 220. Personalization module 220 includes a plurality of content filters 222 to filter content based on determined user preferences. In various embodiments, content filters are pre-generated and personalization module 220 determines which filters to apply for a particular user based on the user's preferences. In other embodiments, personalization module 220 generates content filters specifically based on a user's preferences.

Based on registration information (e.g., conference dial-in number, login information, web address, etc.) from registration module 210, IM (instant messaging) onramp 230 and/or audio onramp 232 connects to the event and begins to receive event content (e.g., instant messages, audio content, etc.). Additional suitable onramps could also be included in server system 200 to receive other types of content (e.g., virtual room displays, documents, etc.). In the case of audio content, automatic speech recognition (ASR) module 234 converts audio content into text.

Filter module 240 filters received event content using one or more content filters 222 to generate customized content for the user. For example, one content filter might specify a user's interest in a particular presenter of content during the live event. Another content filter might specify an interest in any content related to a particular person or subject (e.g., historical figure, famous person, current events, specific location, etc.). Using semantic analysis, filter module 240 compares the preferred content from the one or more content filters to received event content to determine relevance. Irrelevant content is filtered out while relevant content is used to generate customized content for the user.

Content formatting module 250 formats the customized content into an organized and/or aesthetically pleasing format for the user. For example, in an event that includes both audio content and visual displays (e.g., presentation slides in a virtual room), content formatting module 250 might merge audio content (e.g., converted to text) and display content (e.g., based on timestamps, semantic analysis, etc.) to maintain a logical flow of the content and format the content accordingly.

Render module 260 renders the formatted content into a presentation format suitable for the device(s) receiving the content. For example, as part of the registration and/or user preference information, the user might specify a device for receiving the customized content. If the user desires to received the customized content in printed format, the user might specify a printer registered with server system 200. Based on that selection, render module 260 renders the formatted content into a print ready format suitable for the user's particular printer based on known device characteristics (e.g., available media types, sizes, ink colors, etc.).

Render module 260 may also render content for presentation a device other than a printer. For example, the user may select a mobile device, causing render module 260 to format the content specifically for the mobile device (e.g., a mobile app running on the mobile device). In another example, the user may simply specify an email address for receiving the customized content, in which case render module 260 may render the content in PDF (portable document format) or other suitable format for receiving by email. In various embodiments, render module 260 is capable of rendering for multiple different destination devices.

Once content is rendered, communication interface 270 sends the customized content to the user's printer and/or other selected computing device. In some embodiments, event module 280 prevents communication interface 270 from sending the customized content until a timing trigger has been reached. For example, an event organizer or facilitator may provide server system 200 with certain restrictions for accessing the content, including a waiting period for receiving event content after the event has taken place. Content (un-filtered and/or customized) may be retrieved from memory 204 when any designated trigger time has been reached.

In various embodiments, a user might actively engage in a live event while the system participates in the event (e.g., receiving content, analyzing content, preparing customized content, etc.) on the user's behalf. In such cases, the user may submit a request to the server system to print currently-presented content. For example, the event may be an audio conference with a display of presentation slides in a virtual room. Registration module 210 receives the request, and generates a print request that is sent to rendering module 260. Rendering module 260 obtains the currently-presented content (e.g., a presentation slide currently being discussed) and renders the content for the user's printer. The rendered content is then sent via communication interface 270 to the user's printer for printing. The user may then add annotations to the printed content (e.g., to enhance the user's learning, etc.). If the user's printer has scanning capabilities, the user may scan the annotated content and send it back to server system 200 where the scanned document may be added to the customized content prepared for the user for the event.

Various modules and/or components illustrated in FIG. 2 may be implemented as a computer-readable storage medium containing instructions executed by a processor (e.g., processor 202) and stored in a memory (e.g., memory 204) for performing the operations and functions discussed herein.

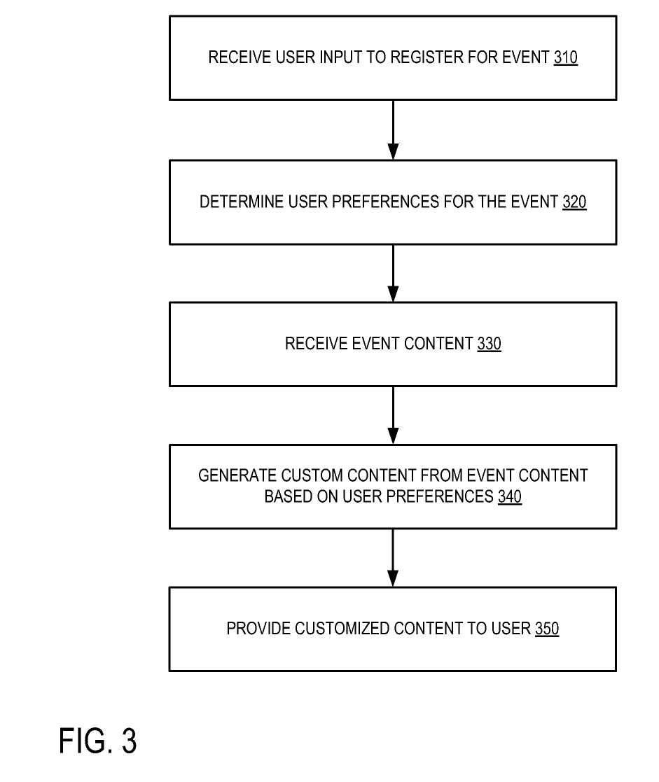

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A server system receives 310 user input to register for a live event. The live event can be a meeting, conference, a session of an on-going course or other event where information is shared and/or exchanged. The user input may include personal information, connection information, login information, etc. The server system determines 320 user preferences for the event. For example, the user might provide information requesting a particular type of content from the event (e.g., content related to specific topic). Alternatively, server system 310 might determine preferences based on historical system usage (e.g., by the user or by groups of users).

At the time of the event, the server system connects to the event (e.g., without user intervention) and begins to receive 330 event content. Again, the server system may connect to the event based on information provided by the user. Alternatively, the server system may connect to the event based on event details (e.g., connection information, etc.) uploaded separately by an event organizer or other event participant. As the system receives event content, the system analyzes the content (e.g., semantic analysis) to determine content that satisfies the user preferences. Based on the analysis, the server system generates 340 customized content for the user (e.g., filters out non-preferred and/or non-relevant content). The system provides 350 the customized content to the user according to the user's preferences and/or profile information. For example, the user may have a web-connected printer registered with the server system that can receive (and print) the customized content. Alternatively, the user might specify an email address for receiving the customized content.

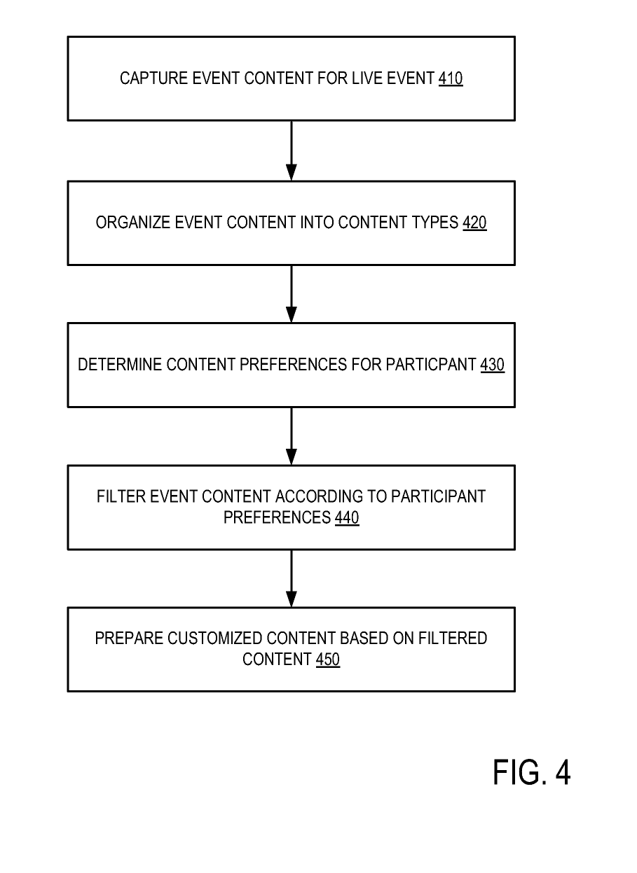

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A server system captures 410 event content for a live event. For example, the server system might use an audio conference dial-in number and conference password to access an audio conference. In another example, the server system might connect to IM conference using associated login information. In yet another example, the server system might use a web address with associated password to access a virtual meeting room. The server system may make multiple connections (e.g., audio and virtual room) for the same live event. Once connected, event content is sent (e.g., streamed) to the server system.

The server system organizes 420 event content into content types. For example, using semantic analysis, the system might organize the content by subject matter. Or, the system might organize the content based on who is presenting the content (e.g., voice recognition, username of person posting a comment/question, identity of person sharing content in virtual room, etc.). The server system could tag same content with multiple content type tags.

The server system determines 430 content preferences for a participant in the live event. Participant content preferences could include speaker/presenter preferences, subject matter preferences, depth of coverage preferences (e.g., short outline vs. detailed transcription, etc.) or other preferences determined by the participant. In various embodiments, the server system solicits the participant for content preferences for a specific event. In other embodiments, the server system allows a participant to establish a user profile with general preferences for event in which the user participates.

Based on the content types for the received content and the content preferences for the participant, the system filters 440 the event content and prepares 450 customized content for the participant.

Various modifications may be made to the disclosed embodiments and implementations of the invention without departing from their scope. Therefore, the illustrations and examples herein should be construed in an illustrative, and not a restrictive sense.

What is claimed is:

1. A method, comprising:
receiving user input to register for a live event;
determining user preferences for the live event;
receiving, via network connection, event content for the live event;
generating customized content for the user from the event content based on the user preferences; and
providing, via network connection, the customized content to the user.

2. The method of claim 1, wherein providing the content comprises sending, via network connection, the content in print ready format to a printing device associated with the user based at least in part on the user preferences.

3. The method of claim 1, wherein providing the customized content comprises:
providing the content to the user upon reaching a trigger time established for the live event.

4. The method of claim 1, wherein the event content comprises at least one content selected from a group content consisting of: instant messaging, audio, visual display, virtual room content display.

5. The method of claim 1, further comprising:
parsing the received event content into categories to facilitate generating the customize content.

6. A method, comprising:
capturing, by a server system, event content associated with a live event;
organizing the event content into content types;
determining content preferences for a participant in the live event;
filtering the organized event content by content type based at least in part on determined user content preferences; and
preparing customized content for the user based at least in part on filtered event content.

7. The method of claim 6, further comprising:
during the event, receiving a request from the participant to print currently-presented content; and
providing, via network connection, the currently-presented content in print ready format to a printer associated with the live event participant.

8. The method of claim 7, further comprising:
receiving an annotated version of the content provided to the participant;
adding the annotated version of the content to the customized content.

9. The method of claim 7, wherein preparing customized content additionally comprises:
preparing customized content for the user based at least in part on device characteristics for a device communicatively connected to the server system and associated with the user.

10. A server system, comprising:
a registration module to receive user input for registering for a live event;
a personalization module to determine user preferences for the live event;
an event connection module to receive event content for the live event;
a filter module to generate customized content for the user from the event content based on the user preferences; and
communication hardware to provide, via network connection, the customized content to the user.

11. The server system of claim 10, further comprising:
a content formatting module to format the customized content; and
a rendering module to render the content in print ready format for a printing device associated with the user.

12. The server system of claim 10, further comprising:
an event module to limit distribution of the customized content until a trigger time established for the live event has been reached.

13. The server system of claim 10, wherein the event content comprises at least one content selected from a group content consisting of: instant messaging, audio, visual display, virtual room content display.

14. The method of claim 1, further comprising:
a plurality of content filters to parse the received event content into content types.

15. The server system of claim 11, further comprising:
the registration module to receive, during the event, a request from the participant to print currently-presented content; and
the rendering module to obtain the currently presented content and render the content in print ready format for a printer associated with the participant.
